(19) United States
(12) Patent Application Publication
(10) Pub. No.: US 2007/0022013 A1
(43) Pub. Date: Jan. 25, 2007

(54) Fitting systems

(76) Inventor: Jodi D. Tousignant, Sutton, MA (US)

Correspondence Address: Jennifer D. Tousignant, 4 Main Street, Westford, MA, 01886, US

(21) Appl. No.: 11/372,396

(22) Filed: Mar. 9, 2006

Related U.S. Application Data
(60) Provisional application No. 60/660,031, filed on Mar. 9, 2005.

(51) Int. Cl. G06Q 20/00

(52) U.S. Cl. 705/22

(57) ABSTRACT

The invention relates to methods that correlate individual size-related measurements provided by a consumer to specifications of articles offered by a manufacturer or a business. The correlation enables a consumer to determine whether a specific article is appropriate for a particular consumer's size and/ or fit needs. Size-related measurements or article specifications may be stored in a database. Articles include items such as clothing, footwear, outer wear. Individuals may be animals or persons.

### CROSS-REFERENCE TO RELATED APPLICATION

This application claims priority under 35 U.S.C. § 119(e) to U.S. Provisional Patent Application Ser. No. 60/660,031, filed on Mar. 9, 2005, the contents of which are hereby incorporated by reference into the present disclosure

### FIELD OF THE INVENTION

The invention relates to methods to fit articles to an individual's physical body.

### BACKGROUND OF THE INVENTION

Individuals routinely select articles to be worn on their bodies using sizes provided by manufacturers or retailers. These sizes, however, fail to reflect the complexities associated with the fitting of two and three dimensional articles to an individual's body. Standard sizing does not does not account for the uniqueness and variances of an individual's body. It is broad and general. Even in the same market, a size label utilized to indicate a particular size for one manufacturer may be identical to that utilized by another, but may represent a different actual fit.

Also, in the growing global markets, the labels utilized to indicate size may not be common or understood by individuals seeking to shop outside of their typical markets. For example, European shoe sizes are represented by numbers such as 35, 36, 37, 38, etc. while United States shoe sizes are represented by numbers such as 5, 6, 7, and 8. Additionally, the labels utilized to indicate size in one country or region may be identical to those used in another, but may not represent the same size. An example may be found in the United States sizing system as compared to the British sizing system, where a size 12 likely represents different sizes or fits.

In addition, there are instances in which the sizes are specific to a certain discipline. In this case, an individual seeking to select an article may know the physical measurements to which the article must match but does not know how to correlate the measurements to the appropriate size with which the article is traditionally related. For example, a person may seek to fit a blanket to a horse of a specific height, body length, and body depth. However, blanket sizes are typically labeled 76, 78, 80, etc. This leaves the individual with little certainty as to the fit of any specific blanket without trying a specific size.

Fit-related issues are one of the primary reasons that consumers, particularly when shopping online, return articles of clothing. Therefore, a need exists in the art to provide a means to solve the issues associated with fit as well as those associated with selecting appropriate sizes for individual body measurements. The instant invention provides a solution to these issues and others. It offers a means by which an individual will know what size or article to select without having to try the article on.

### SUMMARY OF THE INVENTION

The invention relates to methods that correlate size-related measurements of individuals to specifications of articles provided by, for example, a manufacturer or a business. The correlation enables a determination as to whether a specific article is appropriate for an individual's size needs. Size-related measurements or article specifications may be stored in a database. The invention further relates to means to store data related to individual body profiles as well as means to store data related to article specifications comprising measurements relating to the article's dimensions. Articles include items such as clothing, footwear, outer wear. Individuals may be animals or persons.

### BRIEF DESCRIPTION OF THE FIGURE

FIG. 1 provides a flow chart that represents an embodiment of the fitting system provided by the instant methods.

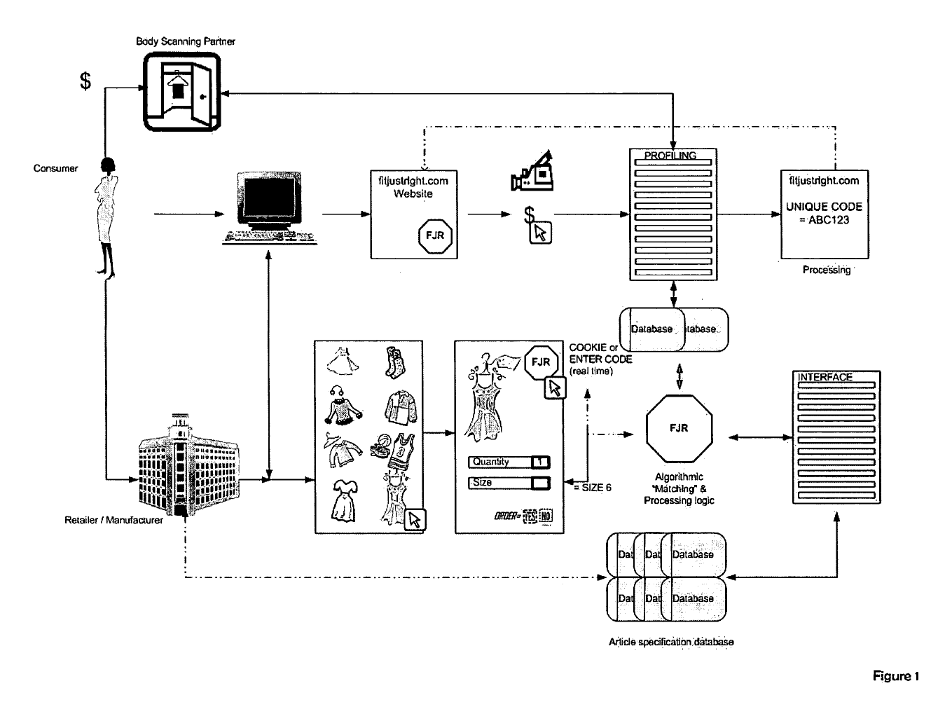

### DETAILED DESCRIPTION OF THE INVENTION

The instant invention, in certain embodiments, bridges a gap that exists between individuals seeking certain articles and manufacturers or retailers offering the sought after articles. It offers a means by which an individual may select articles with ease and minimal effort because the fitting system enables the selection of articles based on measurements customized to the individual.

In another embodiment, the instant invention may provide current data to manufacturers or retailers regarding their consumer base. The databases of the instant invention provide this data. One such database comprises the individual body measurements determined by said individuals, entered into a data processing means, and processed for storage. For example, one hundred thousand body profiles, which represent 100,000 individuals, may be stored in a database. A manufacturer or retailer may then access the information to determine how to alter production to more closely reflect the article size requirements of the consumer base. In one embodiment, the database is designed to interact with the correlating means of the instant invention. In another embodiment of the invention, the database comprises data that has been processed so that the individual body measurements have been associated with a unique identifier code. In one embodiment, the database is designed to interact with the correlating means of the instant invention.

Another database of the instant invention comprises article specifications determined by manufacturers or retailers. These specifications comprise measurements specific to an article's dimensions. Once a database is established, the stored information may be updated to reflect changes in article specifications. It is envisioned in one embodiment that a database would be updated frequently to reflect a manufacturers or retailers currently offered articles.

In one embodiment, the database is designed to interact with the correlating means of the instant invention.

The databases of the instant invention may be hosted by the article producers, a third party, or the service provider.

The instant invention is drawn to methods that enable individuals to select articles of an appropriate size based on individualized measurements. One embodiment of the instant invention relates to an online body profiling service comprising an entry form and database that hosts an individual's personal body profile. A correlating means will connect to a database comprising article specifications determined by manufacturers or retailers. The correlating means will compare an individual's personal body profile to the article specifications. The comparison results in a match to the correct size of the article in which the individual is interested.

In another embodiment, the individual's personal body profile may be represented by a unique identifier code so that the individual only needs to enter the code, rather than the entire profile. The correlating means will connect to 1) a database comprising the processed data wherein the individual body profile is associated with a unique identifier code and 2) a database comprising article specifications determined by manufacturers or retailers. The correlating means will compare an individual's personal body profile as pulled up by the unique code to the article specifications. The comparison results in a match to the correct size of the article in which the individual is interested.

An individual could take the measurements his/herself, could have the measurements representing the personal body profile taken by a third party, or have the measurements taken using body scanning technology known in the art. Once a body profile is established, the stored information may be updated to reflect changes in an individual's profile. For example, individual body changes, may occur in the case of a child developing and aging or as an individual gains or loses weight. The stored information may be updated to reflect changes in and associated with a body profile associated with a unique identifier code.

A personal body profile may be comprised of pre-selected measurements. The pre-selected set of measurements may be a single measurement or may be a plurality of measurements. They may be pre-selected based on an individual's needs, an article's needs, or a manufacturer's or retailer's needs. Examples of measurements suitable for use in the practice of the instant invention include, but are not limited to: bust, chest, waist, hips, inseam, back to waist length, back width, neck circumference, sleeve length to underarm, and upper arm circumference. Such pre-selected measurements may also include any additional measurements that the individual chooses or that are appropriate for the article.

Articles include any article of clothing, footwear, outerwear, or any other item comprising at least two dimensions capable of being fitted to an individual. Examples include, but are not limited to: pants, shirts, jackets, socks, undergarments, shoes, gloves, hats, sweaters, skirts, dresses, blankets, saddles, bridles, helmets.

An individual may be a human or an animal.

The correlating means of the instant invention may be an algorithm. It may be a software program. Those skilled in the software art or the logic arts may easily develop the correlating means. In one embodiment, the correlating means compares an individual body profile to an article's specifications and selects an article that provides the best size match with the profile. The selected article represents an appropriate fit between the individual and the article. The comparison may vary in its determination of fit. The match may be more or less stringent, depending on the particular correlating means. The correlating means may further comprise a means to translate between different measuring systems, for example, between metric and the U.S. system of measurement.

An appropriate fit for a particular individual represents a particular article that matches an individual's profile in the manner defined in advance by the service provider. The appropriate fit may vary based on the type of article.

A manufacturer or retailer is a person, actual or legal, who offers articles to individuals or to other manufacturers or retailers. They comprise a manufacturer, a retail store, or a sole proprietor. The articles may be offered in a physical retail location or online or by mail-order catalog. The nature of the article or the nature of the article offer or does not limit the instant methods.

An exemplary scenario for use of the instant methods can be described as a business to consumer scenario wherein the method is facilitated by a service provider. In this scenario, a manufacturer or retailer partners with a service provider. The manufacturer or retailer accesses the service provider's business through a website portal, which may comprise a graphical user interface. Here, the manufacturer or retailer may enter article measurements that define the physical dimensions of the article offered by the manufacturer or retailer. This entry may be mediated in certain embodiments by uploading data from the manufacturer's databases. The manufacturer may also interface their databases with those of the service provider to provide article measurements. These physical dimensions may be pre-set fields selected for the particular article. They are, for example, bust circumference, chest circumference, waist circumference, hip circumference, back to waist length, back width, neck circumference, etc. These article measurements are stored in an accessible database. The database is likely electronic, although a paper database is possible as well.

The same service provider will also offer a service to individual consumers with which they create a personal body profile. The consumer may access the service provider's services through a website portal, which may comprise a graphical user interface. Here, the consumer may watch an instructional video detailing how to take proper and accurate measurements for a personal body profile. The consumer may then determine the measurements comprising the personal body profile themselves. Optionally, the consumer may have a third party determine the measurement(s), wherein the third party could be a person or a body scanning machine as known in the art. The consumer, or a third party, enters the measurements. The measurements fields may be pre-selected by the service provider. Once the measurements are entered, the service provider uses a processing means to assign the personal body profile a unique identifier code. This code will be associated with the personal body profile and stored with said profile in an accessible database. The database is likely electronic, although a paper database is possible as well. The profile may be updated at any time to reflect changes in the consumer's body.

Once the consumer has been assigned a unique identifier code, the customer may utilize the code to search for articles at manufacturer or retailer partners of the service provider. This is because the service provider provides a correlating means that links the accessible database comprising article measurements to the accessible database comprising the unique identifier code correlated with the personal body profile. The consumer selects an article and enters the unique identifier code. The correlating means accesses the databases, compares the measurements, and selects the article with the correct fit.

Different service providers may create the individual databases connected by the correlating means. In other embodiments, the same service provider creates the databases and provides all the services.

The instant invention may be utilized to select or purchase articles for an individual for whom the personal body profile is created. In other embodiments, the methods may be utilized to select or purchase articles for a third party, wherein the consumer uses the third party's unique identifier to select articles. The unique identifier is not necessarily attached to personal information, providing privacy for the individual while still enabling a third party to select articles for said individual.

In certain embodiments, the instant methods may be used by businesses to select uniforms for their employees.

In other embodiments, the individual body profile data may be interfaced with manufacturing machines capable of producing articles based on the measurements in the profile. This enables the creation of custom clothing in a partially or completely automated fashion.

In another embodiment, global shopping conversions are done automatically by the correlating means of the instant methods. This enables individuals to select articles of non-familiar sizing systems without using conversion tables. This also enables manufacturers or retailers to offer articles in global markets without changing product labels or manufacturing processes.

### EXAMPLES

A prophetic jeans purchase:

An individual creates a personal body profile comprising a set of measurements that may include among others: bust, chest, waist, hips, inseam, back to waist length, back width, neck circumference, sleeve length to underarm, upper arm circumference, and any additional measurements that the individual chooses. The individual enters the measurements comprising her personal body profile into a form provided by a service provider. Upon entry of the data by the individual, a service provider processes the data and assigns a personal, unique identifier code to the profile, which represents the individual's personal body profile. The personal body profile, with its associated code, is stored in an accessible database.

A clothing manufacturer or retail store creates article specification profiles for articles offered for sale, such as a pair of jeans known as “B jeans”. For the B jeans offered, the manufacturer or retail store or sales agent will create a profile comprising the size specifications for each size of B jeans that are offered. These profiles are referred to as article specifications. They would comprise measurements relevant in determining the appropriate size for an individual. For example, they may include waist circumference, inseam, hip circumference. The article specifications for the jeans may be stored in an accessible database. This data may be hosted by the service provider in one embodiment. In another embodiment, this data may be hosted by the article manufacturer and the service provider accesses the data through an interface.

A service provider provides a means to correlate the personal body profile created by the individual with the article specifications provided by the B jeans manufacturer or retail store. To enable the individual to select the correct size of B jeans, the individual would enter her unique identifier code into a system provided by the service provider. The correlation means provided by the service provider would then compare the data represented by the individual's unique identifier code to the article specifications provided by the B jeans manufacturer. Following this comparison, the correlation means would then identify the size of B jeans representing the correct fit for the individual.

A prophetic international jeans purchase

In certain instances, the measurement system utilized by the individual may not be the same as that utilized by the manufacturer or retailer. This is likely common where the individual and the manufacturer or retailer are located in different countries. For example, the individual's measurements could be represented by inches or feet while the manufacturer's or retailer's measurements could be represented in centimeters or meters. In this case, the correlation means provided by the service provider would take into account the conversions required to compare the measurements from the two systems.

We claim:

1. A method comprising:
a) determining a pre-selected set of body measurements specific to an individual;
b) determining a pre-selected set of article measurements specific to an article's dimensions;
c) comparing the measurement specific to the individual with the measurement specific to the article using a correlating means; and
d) determining whether said article is the correct size and/or for said individual.

2. A method comprising:
a) determining a pre-selected set of body measurements specific to an individual;
b) entering said body measurements into a data processing means;
c) processing said body measurements to associate said body measurements with a unique identifier code, wherein said code and associated data are stored;
d) determining a pre-selected set of article measurements specific to an article's dimensions;
e) entering said article measurement into a data processing means, wherein said measurements are stored;
f) connecting the data stored in step c) and step e) via a correlating means;
g) entering said unique identifier code into said correlating means, wherein said correlating means compares the measurement specific to the individual with the measurement specific to the article and determines whether said article will fit and/or match the correct measurements of said individual.

3. A database comprising the measurements in claim 2, step e).

4. A database comprising the code and associated data in claim 2, step c).

5. The method of claim 1, wherein the individual is a human.

6. The method of claim 1, wherein the individual is an animal.

7. The method of claim 2, wherein the individual is a human.

8. The method of claim 2, wherein the individual is an animal.

9. A method comprising:
a) determining a pre-selected set of body measurements specific to an individual;
b) entering said body measurements into a data processing means;
c) processing said body measurements to associate said body measurements with a unique identifier code, wherein said code and associated data are stored;
d) connecting the data stored in step c) to a machine capable of creating an article via a correlating means, wherein said machine creates an article with measurements specific for said individual.
